(19) United States
(12) Patent Application Publication
(10) Pub. No.: US 2023/0233962 A1
(43) Pub. Date: Jul. 27, 2023

(54) MODULAR APPARATUS FOR COLLECTING CANNABIS TRICHOMES

(71) Applicant: John C. Digertt, Inc., Durham, CT (US)

(72) Inventors: John A. Digertt, Durham, CT (US); Brian Pracon, Berlin, CT (US)

(73) Assignee: John C. Digertt, Inc., Durham, CT (US)

(21) Appl. No.: 18/157,964

(22) Filed: Jan. 23, 2023

Related U.S. Application Data
(60) Provisional application No. 63/302,161, filed on Jan. 24, 2022.

(51) Int. Cl. B01D 29/35; B01D 11/02; B01D 35/30; B01D 35/20; B01D 29/56

(52) U.S. Cl. CPC B01D 29/35; B01D 11/0261; B01D 11/0288; B01D 29/56; B01D 35/20; B01D 35/30; B01D 2201/4092

(57) ABSTRACT

A modular apparatus and device for collecting cannabis trichomes includes a collection base that can receive either a standard filter adapter or a nested array of filter baskets on the top thereof. A riser adapter may be located between the collection base and the standard sieve/filter adapter or between the collection base and a nested array of filter baskets. The components are secured using a mounting tab and fastener configuration for ease of installation and disassembly. A vibrator may also be secured to the collection base. The locking tabs of each of the nested array of baskets are configured to have a length so tabs that are vertically stacked over each other co-terminate with each other so they can be secured to a riser adapter or collection base using a single fastener.

### CROSS REFERENCE TO RELATED APPLICATION

This patent document claims priority to earlier filed U.S. Provisional Pat. Application Serial No. 63/302,161, filed Jan. 24, 2022, the entire contents of which are incorporated herein by reference.

### BACKGROUND OF THE INVENTION

The invention related generally to extraction of cannabinoids from cannabis plant material to make hash and other products from the cannabis plant. The invention is particularly related to the collection of trichomes in an efficient and cost-effective manner.

It is well known to extract cannabinoids from cannabis plant material with the assistance of chemical solvents. However, there is serious concern regarding the health issues associated with the use of such chemical solvents for cannabinoid extraction. Besides the increased risk of an explosion in the presence of hazardous materials, the final product could contain a harmful amount of residual solvents. Many government regulations are in place that set cutoff limits for the maximum amount of solvent that can be present in a cannabis product.

Therefore, health-conscious consumers and those using cannabis for medical purposes have turned to solvent-free cannabis extracts to avoid consuming chemical toxins during inhalation. Solvent-free extracts provide customers with a cleaner alternative to solvent-based extracts, such as BHO or CO2 oil.

Cold or ice water extraction of cannabinoids from cannabis plant material is well known in the art for solvent free extraction to address these concerns. It is well known to use ice, water, agitation and filtration to separate the trichomes present on the plant from the raw cannabis material. This process works because the cannabinoids are not water soluble. Moreover, frozen cannabis product is preferably used because the resin gland trichomes can break off from the main plant more easily thereby resulting in a better and complete extraction.

One of the first methods by which hash was extracted without the use of solvents was by hand-rubbing the frozen or cold flower buds and scraping off the sticky trichomes with a knife forming them into a ball. Such a manual method for making solvent free hash is to wash and separate by means of a hand paddle and hand screen. The disadvantages of this method are that it is very inconsistent and very labor intensive. Moreover, replicating the washing and collection process from batch to batch is very difficult to do as well as controlling the temperatures of all vessels. Ice is also needed to keep the product cold and consumes large volumes of ice per batch. Also, the melt rate of ice is difficult to control so, as a result, the temperatures provided by the ice to maintain temperature of the flower buds is very inconsistent. As a result, the end product can be inconsistent in results and in quality.

Further, for collection of trichomes, it is well-known the industry to nested or stacked bags that have decreasing pore sizes along the path of flow of liquid and trichomes. These bags and their positioning relative to each other when nested are not optimized and has limited options.

In view of the foregoing, there is a demand for an apparatus that can efficiently collect cannabis trichomes in a cost-effective manner.

There is also a need for an apparatus that is modular to accommodate different types and sizes of filter elements.

### SUMMARY OF THE INVENTION

The present invention preserves the advantages of prior art solvent-free hash extraction systems and methods and trichome collection devices. In addition, it provides new advantages not found in currently available systems and methods and overcomes many disadvantages of such currently available systems and methods.

The system and method of the present invention takes the inconsistency out of the hash extraction process, namely a cold or ice extraction process, by automating the washing and extraction cycles of the hash making operation. The equipment of the system of the present invention also can record the data and track all user functions. By creating a machine that greatly reduces or eliminates the amount of manual labor out of this process, the time to create the final product decreases and thus more hash product can be produced in a shorter amount of time for better production yields.

Moreover, an object of the present invention is to provide a new and unique trichome collection apparatus, that can be used in an overall cannabis processing system, that is more efficient and cost-effective compared to existing apparatuses.

Another object of the present invention is to provide a trichome collection apparatus that is modular to accommodate different types and sizes of filter/sieve components for efficient collection of trichomes.

### BRIEF DESCRIPTION OF THE DRAWING FIGURES

The novel features which are characteristic of the present invention are set forth in the appended claims. However, the invention’s preferred embodiments, together with further objects and attendant advantages, will be best understood by reference to the following detailed description taken in connection with the accompanying drawings in which:

FIG. 1 shows a side partially broken away elevational view of the cannabis extraction system of the present invention;

FIGS. 2A and 2B show a partial cross-sectional view of a preferred embodiment of the main extraction vessel used a cannabis extraction system of the present invention;

FIG. 3 shows a partial cross-sectional view of an alternative embodiment of the main extraction vessel used in the system of the present invention;

FIG. 4 shows a filtration basket used as part of the separator collection tank; and

FIG. 5 shows a flow chart illustrating the method of the present invention.

FIG. 6 shows the different components of a modular apparatus for collecting cannabis trichomes of an alternative embodiment of the collection tank component of the present invention that uses a standard sieve/filter bag adapter;

FIG. 7 shows the collection base for use with the apparatus of FIG. 6;

FIG. 8 shows the standard filter sieve/filter bag adapter attached directly to the collection base of the modular apparatus;

FIG. 9 shows the adapter riser sleeve for use with the apparatus of FIG. 6;

FIG. 10 shows an assembled modular apparatus for collecting cannabis trichomes of the present invention with a standard filter bag adapter secured to the collection base with an adapter riser sleeve therebetween;

FIG. 11 shows a top perspective view of a further alternative embodiment of the present invention that includes a nested filter basket with a rigid frame of the modular collection tank apparatus of the present invention;

FIG. 12 shows the basket of FIG. 11 being aligned on the top edge of the adapter riser sleeve;

FIG. 13 shows a front perspective view of a nested array of multiple filter baskets attached to the collection base with adapter riser sleeve residing therebetween of the modular apparatus; and

FIG. 14 shows a top perspective view of the nested array of multiple filter baskets attached to the collection base with adapter riser sleeve residing therebetween of the modular apparatus of FIG. 13.

### DESCRIPTION OF THE INVENTION

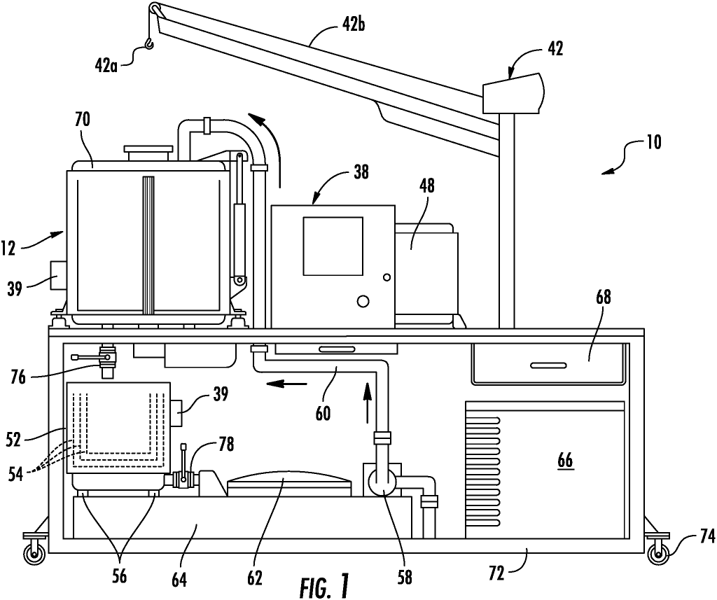

As can be seen in FIG. 1, a side partially broken away elevational view of the cannabis extraction system 10 of the present invention is shown. The system 10 is a complete hash washing, extraction and collection production plant configured and arranged in an all-in-one system that includes its own chiller and chilled water make up system. This system 10 is an example environment for use of the modular apparatus for collecting cannabis trichomes of the present invention. As can be understood from the below, the modular apparatus of the present invention can be used in any cannabis processing system.

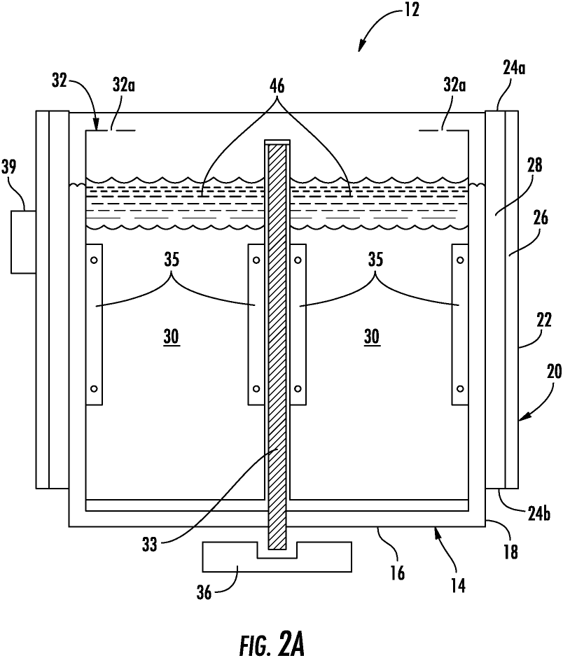

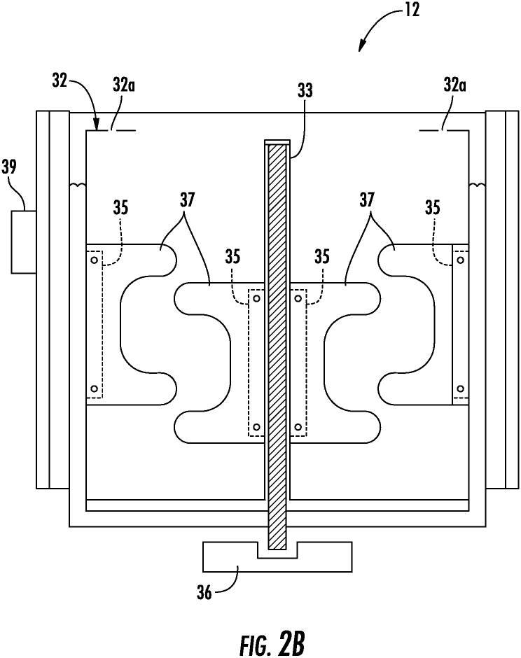

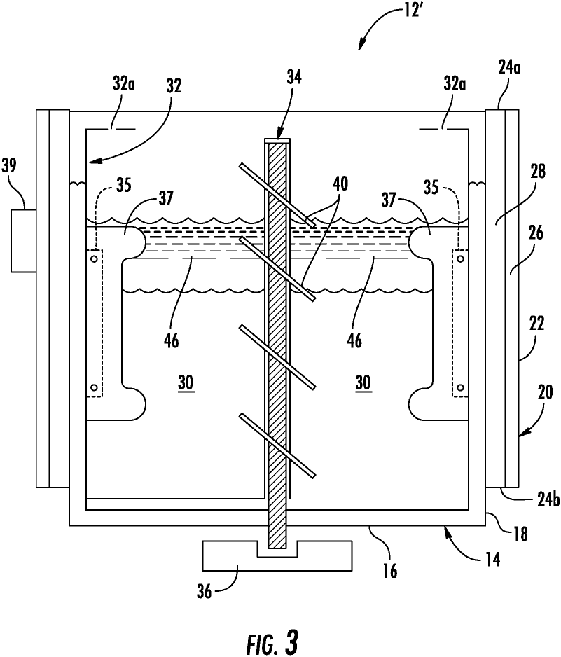

The system 10 of the present invention first includes a preferred embodiment of a main extraction vessel 12 that is preferably a multi-wall tank, such as a triple wall construction. Details of the triple wall construction of the main extraction tank 12 are shown in FIGS. 2A, 2B and 3. The preferred embodiment of the main extraction tank 12 includes an inner tank 14 with a tank bottom 16 and side/outer walls 18. Surrounding the inner tank is a wall construction that includes an exterior tank 20 that preferably has an outer wall 22 that is stainless steel with a brushed finish but may have other finishes, such as a mirror finish. The outer wall 22 includes encapsulating top member 70, as seen in FIG. 1, and bottom flanges 24a, 24b to contain an insulation jacket 26 and an intermediate glycol jacket 28 therein. Preferably, the glycol jacket 28 is positioned adjacent to the inner tank wall 18. Also, the insulation jacket 26 is preferably positioned between the glycol jacket 28 and the stainless steel exterior tank 20. The intermediate jacket 28 is preferably made of glycol but can be other materials. Further the outer insulative jacket 26 is preferably made of closed cell polyurethane foam but can be made of any appropriate insulation material.

It should also be understood that the use of a triple wall construction with a glycol jacket and an insulation jacket is a preferred embodiment of the present invention. However, other configurations of wall construction, such as a double wall or single wall construction, are still contemplated and within the scope of the present invention.

The entire system 10 is preferably configured on a large frame 72 with wheels 74 for ease of transport of the entire system 10.

The multi-wall construction of the present invention therefor provides a defined inner space that can be efficiently chilled via the glycol jacket 28 that interfaces with the outer surface of the inner tank wall 18. The outer insulation jacket 26 is insulated, which allows the inner tank 14, containing the frozen cannabis flower 30, to be chilled more efficiently and consistently.

Still referring to FIGS. 2A, 2B and 3, a removable, preferably stainless steel, washing mesh basket 32 is provided. The removable mesh basket 32 slidably resides inside the inner tank wall of inner tank 14.

FIGS. 2A and 2B show a preferred embodiment of the mesh basket that includes an internal post 33 fixed to the mesh basket 32 so that the post 33 rotates with the mesh basket. As seen in FIG. 2A, a number of internal agitation paddle mounting brackets 35 are fixed to the internal female drive hub and on the interior wall about the periphery of the mesh basket, such as by welding. FIG. 2B shows agitation paddles 37 secured to the mounting brackets, by removable fasteners, such as bolts and the like. The size, shape and configuration of the agitation paddles 37 can be selected to suit the job at hand, the cannabis strain being processed as well as the required processing parameters. For a different job, the paddles 37 may be easily switched out for different paddles. To assist with agitation during soaking and washing, one or more preferably adjustable vibrators 39 may be affixed to the exterior of the main extraction tank 12 to keep product moving and increase separation.

It should be understood that the internal post 33 and basket 32 arrangement may also be rotated and reciprocated using any known drive mechanism, including any gears or linkages interconnected to a motor that interconnected to the control system 38, as shown in FIG. 1, of the present invention and includes an internal 8 female spline coupler/drive hub 36 for driving/rotating the post and basket attached thereto with paddles affixed thereto. This allows for precise control of the rotation, in both directions, of the basket 32, for the soaking and washing steps described in detail below.

In the alternative embodiment 12′ of the main extraction tank of FIG. 3, the washing mesh basket 32 includes an integrated auger 34 about an internal 8 female spline coupler/drive hub 36 similar to the drive used in FIGS. 2A and 2B. The auger 34 has a helical “paddle” 40 that is permanently fixed to the mesh basket 32 and rotates therewith. Removable and customizable paddles 37 are also attached to the interior of the outer wall of the mesh basket 32 in similar fashion to the preferred embodiment 12 of the extraction tank of FIGS. 2A and 2B. It should be understood that the auger 34 and basket 32 arrangement may also be rotated and reciprocated using any known drive mechanism, including any gears or linkages interconnected to a motor that interconnected to the control system 38, as shown in FIG. 1, of the present invention for precise control of the rotation of the auger 34 and basket 32 for the soaking and washing steps described in detail below.

The tanks 14, 20 and various components of the cannabis extraction system of the present invention, such as the internal post 33, auger 34, paddles 37 and basket 32, are preferably made of a sanitary material that can be easily and quickly cleaned, such as stainless steel.

At the top of the mesh basket 32, whether it includes a post 33 with paddles 37 removably attached thereto or a fixed auger 34 with helical paddle 40, are a number of basket handles/lifting eyes 32a to facilitate installation into the inner tank 14 as well as removal from the inner tank 14. The system 10 is preferably equipped with a winch 42, such as a 2000 pound power winch, to help install and remove the mesh basket 32, containing cannabis plant matter 30 therein, from the inner tank 14. For example, the mesh basket 32 is preferably lifted by the hook 42a and cable(s) 42b of the winch 42.

As can be understood, the removable basket 32 increases productivity because once a loaded basket 32 has been processed and spent as a result, another basket 32 loaded with new cannabis that is ready for processing can quickly and easily replace the already processed spent basket 32 to cut down on down time. Thus, multiple baskets 32, pre-loaded with material 30 for processing, can be prepared in advance to speed up processing of multiple batches of material 30. Moreover, the removeable mesh basket 32 also allows for quicker and easier cleaning of the main extraction vessel 12. Also, cleaning of the mesh basket 32 is greatly facilitated when it can be separated from the rest of the system 10 for its own cleaning and then subsequent loading with cannabis material 30 for extraction and collection processing.

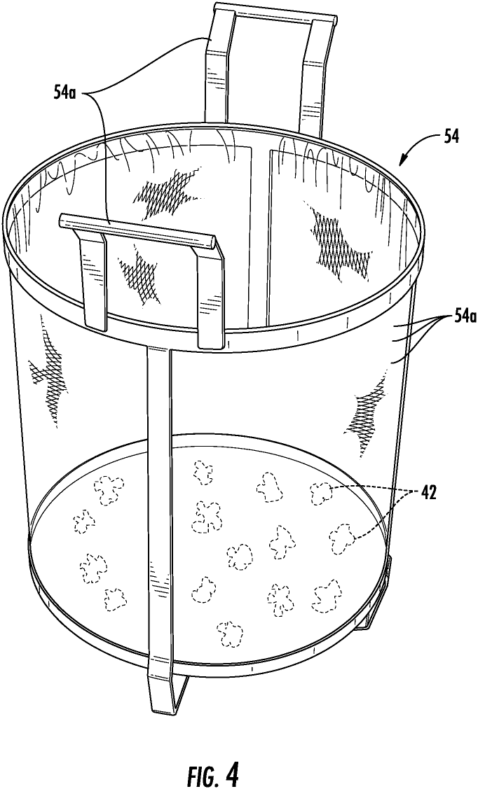

In operation, according to the method 100 of the present invention as can be seen in FIG. 5, the removable mesh basket 32 is first loaded with frozen “raw” cannabis flower material 30 at step 102. It should be understood that the system and method of the present invention greatly facilitates and automates water-based cannabis extraction by use of ice, water, agitation and filtration to separate the trichomes present 42 on the plant from the raw cannabis material 30. This process works because the cannabinoids are not water soluble. Moreover, frozen cannabis product 30 is preferably used because the trichomes 42, as seen in FIG. 4, can break off from the main plant more easily thereby resulting in a better and complete extraction.

For example, as stated above, multiple mesh baskets 32 can be loaded with such material 30 in preparation for processing. The mesh basket 32, loaded with frozen raw cannabis flower material 30, is slid into, and installed into the inner tank 14 to a position of that shown in FIG. 2 and as seen in step 104 of FIG. 5. The extraction vessel 12, with mesh basket 32 and cannabis 30 flow therein and now residing in the inner tank 14, is then filled with water 46, as in step 106 of FIG. 5. More specifically, the main extraction vessel 12, with a loaded basket 32 installed therein, is filled with clean treated and chilled water 46 that comes from a triple wall stainless steel make up water tank 48.

In accordance with the present invention, the system and method are preferably automated and computer controller 38 to facilitate repeatably and accurate operation of the system 10 of the present invention. For example, the present invention includes a main controller 38 for such operator control of the system to carry out the method. More specifically, the operator uses the main controller 38 to instruct the system to fill the main extraction vessel 12 or 12′ with an exact amount of water 46 every cycle to allow for exact cycle repetition every time. For example, the computer controller 38 (and control panel associated therewith) can be fully programmed to control speed, time, alternating speed, alternating time, direction in a multi-stage program to customize each step of each cycle. As a further example, the controller 38 can be programmed to allow for multiple “sections” of washing where the wash cycle can be broken down into a beginning, middle and end and have different speeds and directions of rotation and times in each section. The foregoing is fully monitored, recorded and saved for future batches for quality control, efficiency, repeatability and the like. For example, the main controller 38 can monitor and record and provide alerts and alarms for parameters such as high temperatures, low temperatures, high or low water level in storage tanks, glycol temperature, as well as over, high and low speeds, and the like.

Once the main extraction vessel 12 or 12′ is loaded with frozen product 30 and the water 46 is introduced, a soaking step 108, in FIG. 5, is ready to be begin. The controller 38 causes the basket 32 and agitation members 37 and/or 40 to slowly begin to spin and alternate direction and give the product 30 time to soak, in a repeatable automated fashion.

The operator can adjust and pre-program the time speeds and direction of all functions in the main controller cabinet 38 to accommodate different types of product 30 that is being processed and to adjust the amount and manner of soaking/washing, as needed for the current job. The programming of the operation, including for soaking and washing, can be saved for easy recall and accurate repetition of the process.

Once the soaking cycle 108 is over, the washing cycle 110, seen in FIG. 5, can begin. The machine washes by rotationally reciprocating the wash basket 32, and paddles 37 in FIGS. 2A and 2B or auger 34 and paddles 40 in FIG. 3, back and forth for a predetermined amount of time, cycle and speed. All of these parameters can be adjusted and preprogrammed to suit the job at hand.

Once the wash cycle is completed and water is drained from main extraction vessel and all trichomes are collected as described below, the spent product that was just washed is preferably spun at high speed in a “dry” cycle to remove water and make the wasted product weigh less and cost less to dispose of as well as mitigate mold growth while waiting to dispose of such spent product. Such drying can also allow the product to be reused in another process, such as being extracted in an ethanol extraction system or butane or C02.

After the desired washing cycle(s) are complete, the operator drains the main extraction vessel 12 as in step 112 of FIG. 5, via output valve 76, into a double wall stainless steel insulated separation/collection tank 52 that is preferably positioned directly below the main extraction vessel 12 or 12′. This is carried out by the assistance of gravity and avoids exposing the extracted product 42 to any mechanical pumps or added heat. The insulated stainless-steel separation/collection tank 52 includes filter media screens, such as a filter basket 54 with handles 54a in FIG. 4, where draining media flow therethrough (containing water 46 and trichomes 42) and then into the separation/collection tank 52 thereby providing a cold collection place. An array of filter media 54 of different pore sizes can be used to carry out the desired filtration, as in step 114 of FIG. 5, to collect the desired cannabis product for later processing. A single filter media basket 54 is shown in FIG. 4, other filter baskets 54 are similar but with different pore size holes 54a therein. Such a graded filtering of trichomes 42 is well known to separate out and collect such trichomes for later drying and processing. The present invention can take advantage and employ such graded multi-stage filtering for optimal collection of trichomes 42.

For example, they system and method of the present invention may use known “bubble bags” (not shown), which are very well known in the art. These bags are typically made of nylon but can be made of other materials. Alternatively, as seen in FIG. 4, a metal drop-in basket filters 54 may be employed instead to replace the mesh bubble bags to provide a more commercial and durable filtration solution compared to nylon sacks or bags. The metal filter baskets 54 are preferably made of stainless-steel but can be other metals or even other materials. In accordance with the present invention, is also envisioned that a mixture of nylon bags and stainless-steel metal basket filters 54 may be employed to suit a given process, cannabis strain or other processing requirement at hand.

Whether nylon bags or metal mesh basket filters 54 are used alone or in combination with each other, multi-stage graded filtration is desired for quality filtration. For example, such stacked filters (whether nylon bags, metal filter baskets 54 or a combination thereof) are preferably used to separate out unwanted debris and different quality trichomes 42 (due to size) from a cold/ice extraction process of the present invention. Preferably, the filters, generally referred to as 54, are stacked/nested form where the largest pore size bag or filter basket 54 is at the top and where the bags or filter baskets 54 have a successively smaller pore size as the water 46 and trichomes 42 travel together downstream/downward with the assistance of gravity. Although not limited to this array, below is an example array of filters 54 with different micron pore sizes that may be used with the system and method of the present invention 10 and what each filter typically collects:
● 220 micron filter (typically debris being filtered out)
● 190 micron filter (typically debris being filtered out)
● 160 micron filter (typically low quality trichomes)
● 120 micron filter (typically high quality trichomes)
● 90 micron filter (typically the best quality trichomes)
● 73 micron filter (typically high quality trichomes)
● 45 micron filter (typically medium quality trichomes)
● 25 micron filter (typically low to medium quality trichomes)

To assist with agitation during soaking and washing, one or more preferably adjustable vibrators may be affixed to the exterior of the separation/collection tank to keep product moving and increase separation and improve filtering. This is preferred over the prior process of manually shaking “bubble bags” by hand as it is more reliable, more consistent and much less labor intensive.

As can be understood, after filtration, the nylon bags, metal filter baskets 54, or combination thereof, are individually be slid out and removed from the separation/collection tank 52, as also seen in step 116 of FIG. 5. Then, the trichomes 42 are retrieved from each filter bag or filter basket 54 and then further processed, as seen in step 118 of FIG. 5, such as being placed on drying parchment paper (not shown), and the like.

Therefore, as the water 46 and extracted trichomes 42 pass through the filter screens 54 and then drain into the double wall stainless steel separation/collection tank 52, the cannabis trichomes 42 are collected on the screens. The separation/collection tank 52 is sized to allow an entire cycle of water 46 to collect in it and remain chilled until it is needed for the next cycle. Also, for ease of cleaning the separation/collection tank 52 is positioned on slide-out rails 56 so the operator may gain easy access to the interior of the separation/collection tank 52 and the filter screens 54 therein, particularly for cleaning thereof.

The chilled water makeup tank 48, that was previously used to fill the main extraction vessel 12 with chilled water 46, also provides water 46 for a cleaning operation where the operator carries out a chilled pressurized wash down of the screens 54 in the double wall separation/collection tank 52. Once the screens 54 are washed, the slide out rails 56 under tank 52 facilitates the operator to easily slide out the tank 52 from under the unit, remove the screens 54 and then thoroughly clean this separation/collection tank 52.

As can be understood, once the main extraction vessel 12 or 12′ is reloaded with a new mesh basket 32 pre-loaded with frozen product 30 to be processed, the operation and method of the present invention can be started and then carried out again. Several mesh baskets 32 may be pre-loaded with frozen cannabis product 30 in advance to facilitate processing of such several pre-loaded baskets 32 of cannabis flower 30 in rapid succession thereby reducing the overall time of processing.

Moreover, the water 46 in the insulated holding tank 48 can be brought back into the main extraction vessel 12 or 12′, if desired, via a sanitary pump 58, via pipes 60, that is controlled by the main controller cabinet 38. This allows the operator to replace an exact amount of water 46 into the process time and time again, as needed to suit the current job. As above, this function can also be saved for future batches for accurate repeatability of the process.

As shown in FIG. 1, a 24″ manway access port/door 62 is used for cleaning and access to an insulated holding tank 64, which is preferably a 55-gallon insulated surge storage reservoir. This permits all water 46 that exits from the separation/collection vessel 52, via valve 78, into holding tank 64 so it can be held in a clean and insulated space in between wash cycles. This is to ensure that the exact same quantitate and water 46 is reused in each successive wash cycle after the first cycle to ensure consistent repetition of the processing. A ¾ ton cold chiller 66 is used to chill food safe glycol that is routed into the glycol jacket 28, as seen in FIGS. 2A, 2B and 3, to chill the main extraction vessel 12 or 12′ as well as the chilled water make up tank 48. This enables refrigeration/chill of these tanks to eliminate the need for unreliable ice to be used in this operation in accordance with the present invention. With the assistance of the controller 38, the chiller 66 can be set on a schedule to start and stop at specific times and dates, in similar fashion to a programmable thermostat. Also, storage drawer 68 is used for easy ergonomic access to all cleaning tools and spare parts for this machine and keeps them in an easy to clean and reach space. The inner draw is also removable for periodic cleaning.

Once the hash resin trichomes 42 is extracted using the system and method of the present invention, as mentioned above, it requires further processing before consumption. For example, the collected trichomes 42 will typically be laid out on parchment paper for drying and further processing. For example, the resin trichomes 42 is commonly cut or chopped and then stored so it may dry. The drying process may be carried out in many different ways. Since such drying is so well known in the art, it need not be discussed further herein.

Referring back to FIGS. 1 and 4, an array of filter media 54 of different pore sizes can be used to carry out the desired filtration, as in step 114 of FIG. 5, to collect the desired cannabis product for later processing. As noted above, one embodiment of a filter basket 54 for stacking with handles is shown in FIG. 4. Such a graded filtering of trichomes 42 using multiple filter elements is well known to separate out and collect such trichomes for later drying and processing. The present invention provides an improved apparatus with array of such filter elements (sieves), such as in the form of baskets, that is more efficient and provides superior filtration results compared to prior configurations known in the industry. The improved apparatus for collecting cannabis trichomes of the present is as described in detail below and shown in the attached figures.

Prior designs, such as seen in FIG. 4, provide a stainless-steel basket or sieve used for trichome collection. Such know designation include a substantially cylindrical shape with filter media on the sides and bottom of the basket. Support feet are commonly provided on the bottom of the basket and a pair of handles are also commonly provided to lift and transport the basket, as needed. As is very well-known in the prior art, an array of such filter baskets 54 are provided in separation/collection tank 52, as in FIG. 1. An array of baskets 54 are stacked/nested where the largest pore size filter basket 54 is at the top and where the bags or filter baskets 54 have a successively smaller pore size as the water 46 and trichomes 42 travel together downstream/downward with the assistance of gravity. In the embodiment of FIG. 4, the nested filter baskets rest within each other and the feet provide some level of spacing. However, such stacking/nesting of filter baskets is quite loose so it can be inefficient because the filter baskets 54 can move relative to each other. Also, a loose stacked/nested array of filter baskets are not well-suited for receiving vibration, which is helpful for collection.

In general, the apparatus for filtering trichomes array construction of the present invention includes full mesh sides is to increase filtering surface area and speed up the speed at water can pass through them. For example, an array of one or more, such as eight, filter basket configuration in ascending micron can be employed in accordance with the present invention. In general, the apparatus with improved filter array of the present invention includes one or more nested baskets within an insulated space with water collection bellow it. This insulated or chilled space also has an adjustable vibrator that vibrates the filter/sieve basket stack thereby increasing filtration efficiency. Also, with the filter array of the present invention experiences decreased screen blinding while filtering, which is when oversize particles form a filter cake on top of the filter that may block the filter lattice, preventing fluid from crossing the filter. As can be understood, such filter screen blinding should be avoided in connection with use of such a filter array for collecting cannabis trichomes. Also, it is preferred that the array of screens remain above any water storage area of this space to keep the collected trichomes from degrading and changing color from wastewater that is present.

As part of the apparatus of the present invention, the collection vessel that houses bubble bags or stainless filter screens is preferably chilled with a glycol jacket like the wash vessel discussed above to keep the collected trichome material cold during the collection process as well as keep the water being used in the extraction process cold while it is being recirculated. There is preferably an inline heat exchanger provided after the water pump from the collection vessel to the main wash vessel to re-chill the water and ensure it is cold and no added temperature is seen while operating this system in a closed loop application. The collection vessel can also be triple wall chilled and insulated just like the main vessel.

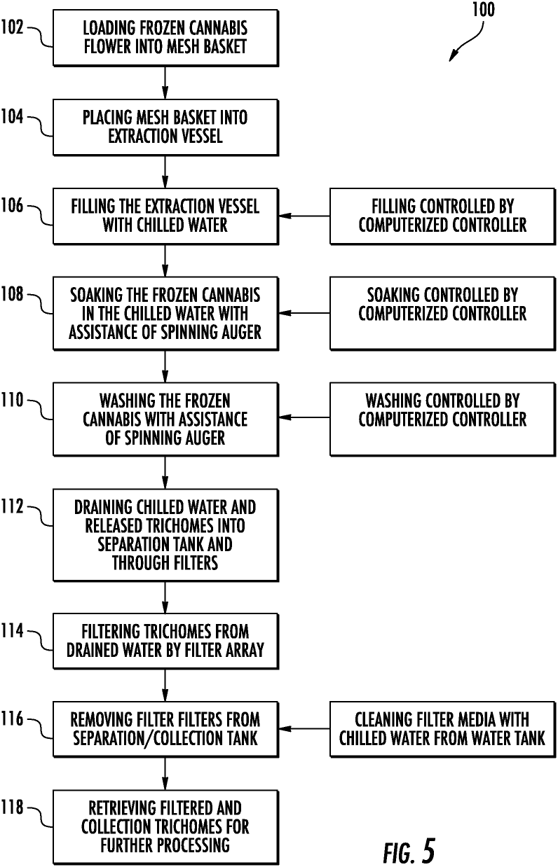

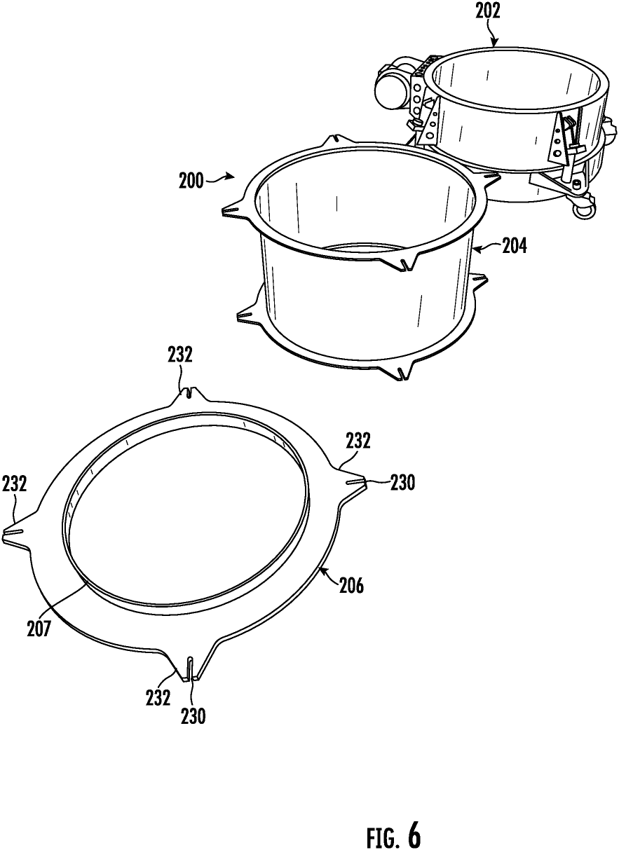

The present invention, as claimed herein, is directed to alternative embodiments 200, 300 of the separation/collection tank 52 and the nested and graded filtration bags or baskets that are shown in FIGS. 1 and 4. More specifically, the present invention is shown in FIGS. 6-14 to provide an improved modular apparatus 200, 300 for the collection of cannabis trichomes 42 over the separation/collection tank 52 as a part of the entire processing of cannabis using the system 10 of FIG. 1, as an example, or any other cannabis processing system that includes the step of collection of extracted trichomes.

As seen in FIGS. 6-14, improved modular apparatus 200, 300 for the collection of cannabis trichomes 42 of the present invention and its components can be seen in detail. The unique nested filter array construction provides for a modular system for providing a separation/collection tank.

Turning to FIGS. 6-10, a first embodiment 200 of the modular apparatus for the collection of cannabis trichomes 42 of the present invention is provided in a configuration for the use and accommodation of standard filter bags/sieves. In FIG. 6, the components of an insulated vibrator collection base 202, optional and removable adapter riser/sleeve 204, and standard sieve/bag adapter 206 are shown in an unassembled form.

FIG. 7 shows the components of FIG. 6 assembled. The insulated vibrator collection base 202 includes a main cylinder 208 with a top edge 210. A ring frame 212 has a number of brackets 214 with wheel or caster assemblies 216 attached thereto. Locking brackets 218 are attached to the side walls 208′ of the cylinder 208 and those locking brackets 218 are attached to the ring frame 212 via cushioning members 220, which are preferably rubber, or the like. Thus, the collection tank base 202, in the form of a cylinder 208, can be wheeled around for ease of transport, which is particularly helpful after it has been filled with trichomes that have been collected. Moreover, with the use of the cushioned floating design, the cylinder 208 can be vibrated, by attached vibrator 222, for improved collection of trichomes without providing significant vibration and instability to the supporting ring 212 with casters/wheels thereon 216.

Still referring to FIG. 7, attached to the locking brackets 218 or directly to the side of the cylinder 208 are pivoting threaded fasteners 224 with a knurled lock member 226. The locking brackets 218, threaded fasteners 224 and knurled lock member 226 are collectively referred to as the locking system. As will be described in detail below, the locking system secures various other components to the top edge 210 of the insulated vibrator collection base 202 in modular fashion to configure the collection for the needs of a given cannabis processing event. A vibrator 222 is also preferably attached to the side of the collection base 204 to provide vibration to the collection base 202 for improved collection of cannabis trichomes 42.

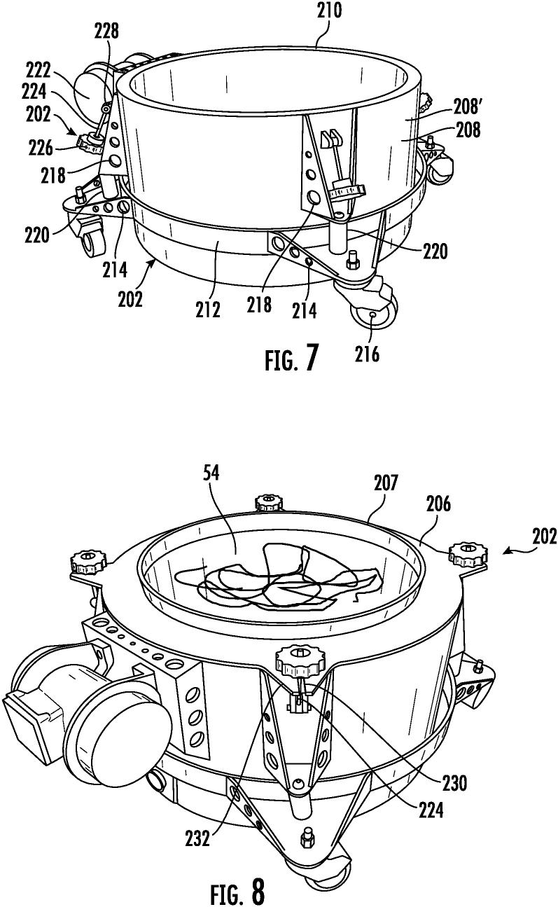

As best seen in FIG. 8, an insulated vibration collection base 204 is provided that preferably includes casters 216 on the bottom thereof so it can be easily transported by rolling on a floor, as described above. The base 202 is of a substantially tubular construction but can be of any shape. A number of pivoting locking fasteners 224 are provided to secure either a standard filter/sieve adapter 206, riser/spacer sleeve 204, as seen in FIG. 6 or filter baskets thereto (as discussed below). The vibrator 222 can also be seen in FIG. 8 where it is attached to the side of the collection base 202 via bracket for providing helpful vibration to encourage filtration through the nested sieves/filters.

FIG. 8 shows a standard sieve/filter adapter of FIG. 6 releasably secured directly to the top peripheral edge 210 of the collection base 202. The pivoting fasteners 224, 226 are pivoted upwardly about a pivot point 228 to reside in gaps 230 between respective tabs 232 about the periphery of the standard filter/sieve adapter. In other words, the gap 230 splits each tabs 232 into a pair of smaller tabs that receive the threaded fasteners 224 therein. Then, the hand-tightened knobs 223 are screwed down to secure the standard sieve/filter adapter 206 in place. The standard adapter 206 includes a top ridge 207 to serve as an adapter to accommodate and receive a set of standard sieve/filter bags 54, as is well-known in the art and generally represented in FIG. 8. Preferably, four split tabs 232 a respective locking members 224, 226 are provided about the periphery of the cylinder 208 but more or less than four locking members 224, 226 can be employed.

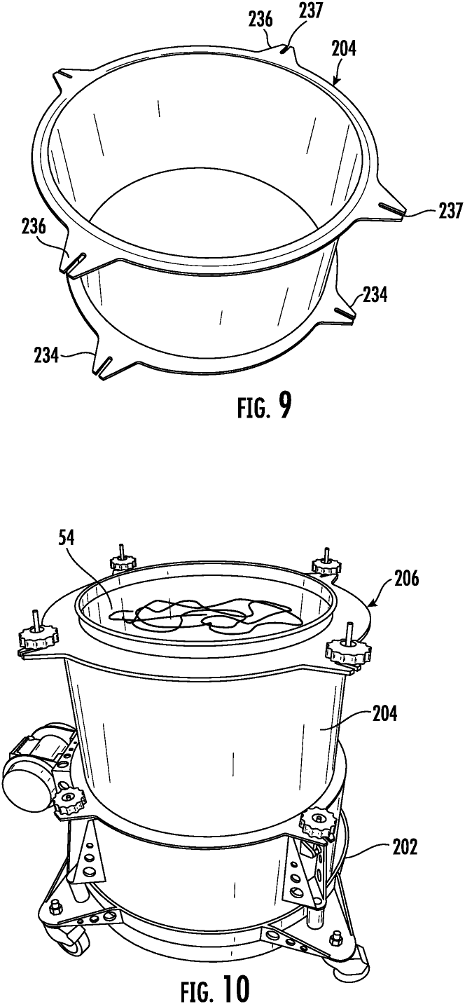

If the standard filter bags 54 are deep/long, the riser sleeve 204, as seen in FIGS. 9 and 10, for example, where the adapter riser sleeve 204 is first attached and locked to the collection base 202 in the same fashion as described above by first securing the adapter riser 204 to the collection base 202 using the lower set of split mounting tabs 234 on the riser adapter sleeve, as seen in FIG. 10. Upper mounting tabs 236 are also provided. Then, the standard filter/sieve adapter 206 can then be installed on the top of the adapter riser 204 via the upper set of mounting tabs 236, as in FIGS. 9 and 10, instead of directly to the top edge 210 of the collection base 202, as seen in FIG. 8. Therefore, a standard set of nested bags 24 can be used in an embodiment of the modular apparatus 200 of the present invention for the collection of cannabis trichomes 42.

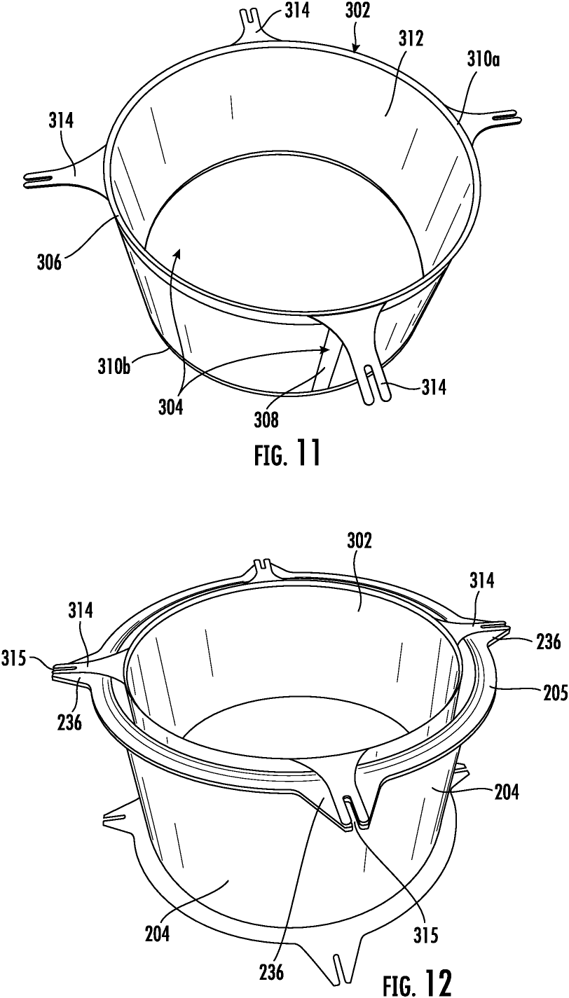

Also, the modular cannabis collection construction of the present invention can accommodate other types of filter media. For example, FIGS. 11-14 show how the modular apparatus 300 for collecting cannabis trichomes of the present invention can accommodate a nested basket array that is secured in a spaced apart configuration for superior performance. One of such filter elements 302 in the form and configuration of a basket is shown in FIG. 11. This basket 302 has a construction that is rigid so it maintains its shape compared to a well-know prior art filter bag 54 that is commonly uses in a filtration array for collecting cannabis trichomes 42. The filter basket 302 includes a rigid frame 304, which is preferably metal but could be of other materials, such as plastic. The rigid frame 304 is preferably generally cylindrical in shape with cylindrical side walls 306 that are reinforced with vertical struts 308 and upper and lower rings 310a, 310b, as can be seen in FIG. 11. The filter media 312 is attached to the frame 304 to provide a basket-like configuration with cylindrical side walls and a floor filter panels 312. At least one tab 314, such as four tabs 314, emanate laterally outwardly from the upper ring 310a of the frame 304 of the filter basket 302. Each of the tabs 314 are split in similar fashion to the tabs 236 located on the standard sieve/filter adapter 204, as seen in FIGS. 6, 8, and 10 and the split tabs 236 on the sleeve/rise adapter, as seen in FIGS. 6 and 9, for example. These common tabs 236 on different components of the apparatus of the present invention are be modular so such components can be mixed and matched for attachment to the collection base component 202.

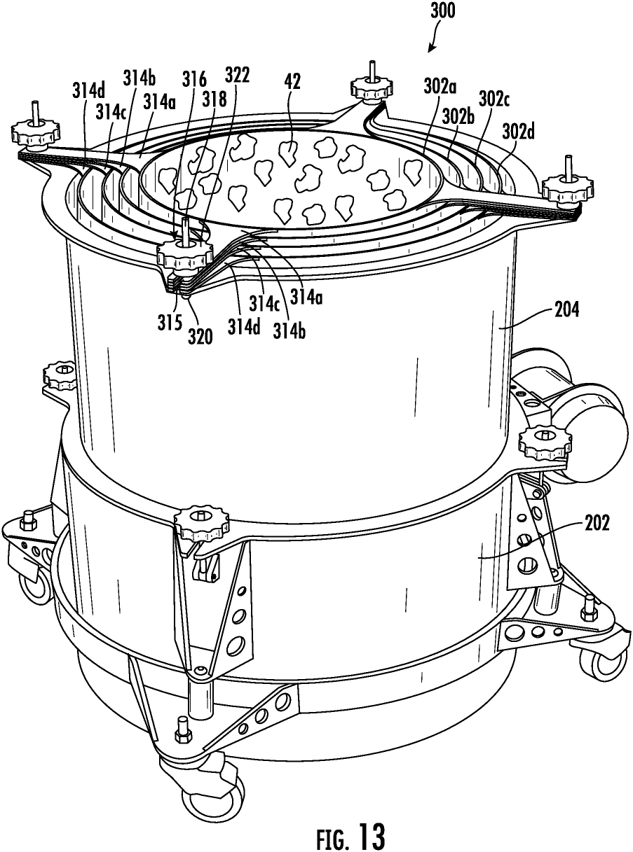

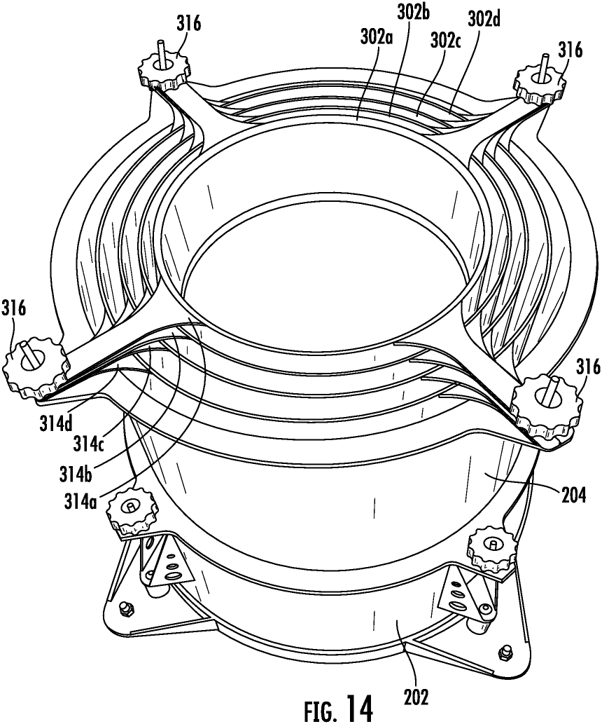

FIG. 12 shows a first filter basket 302 of the configuration of FIG. 11 that is arranged on the top edge 205 of the adapter riser 204 so the mounting tabs 314 on the top edge 205 of the riser 204 align with the tabs 236 on the filter basket 302. More specifically, the gaps 315 in each of the split tabs 314 on the filter basket 302 align with the gaps 237 in the split tabs 236 in the riser 204. Alternatively, the filter basket 302 may be arranged directly on the top edge 210 of the collection base component 202 in similar fashion to the standard filter/sieve adapter 206. However, with the rigid nested filter baskets 302 of the type shown in FIG. 11, it is preferred that the riser adapter 204 be used, as in FIGS. 12-14, to provide additional vertical clearance for larger filter baskets 302 and accommodation of more trichomes 42 and additional drained water from the extraction system if an outlet port is not provided in the collection base component 202. While not shown in FIGS. 13 and 14, an outlet drain port with a valve can be included in the collection base component in similar fashion to the collection base 52 of FIG. 1.

Turning now to FIGS. 13 and 14, multiple filter baskets 302a-d are nested/stacked onto each other in the desired mesh size order where the tabs 314a-d of each basket 302a-d are respectively aligned over the tabs of neighboring baskets in the stack. Moreover, the gaps 315 of each of the split tabs 314a-d of each stacked filter basket 302a-d are aligned with each other. Thus, the gaps 315 at a given location would also be aligned with each other. Thus, a single fastener 316 can pass through each gap 315 of aligned tabs 314a-d to simultaneously secure all vertically stacked tabs 314a-d at a given position to the top surface of the adapter riser 204 (or directly to the top of the collection base). The fastener 316 is preferably a threaded bolt 318 with a head 320 that is larger than the gap 315 in the split tabs 314a-d where the threaded portion of the screw 318 is long enough to extend through all of the tabs 315 of the stacked filter baskets 302a-d to receive a female threaded knob 322 so that the stack of tabs 314a-d are secured to each other in clamping fashion. The threaded knob 316 can be hand-tightened for ease of assembly without the use of tools.

Such stacking and securing of multiple baskets 302a-d to the top of the adapter riser 304 can be seen in FIGS. 13 and 14. As is well-known in the art and discussed above, preferably, the filter baskets 302a-d are stacked/nested where the largest pore size bag or filter basket is at the top and where the filter baskets have a successively smaller pore size as water and trichomes 42 travel together downstream/downward with the assistance of gravity. Thus, when stacked, the smallest basket 302a in the center has the largest pore size filter media and each successive basket outward has a gradually smaller and smaller pore size. This generally follows the filter array 54 of collection base 52 shown in FIG. 1. In the case of the embodiment of FIGS. 13 and 14, the filter media is the rigid filter baskets 302a-d. In the case of the embodiment of FIGS. 8 and 10, the filter media is flexible filter bags (bubble bags) 54.

Also, is should be noted that the length of the tabs 314a-d on each basket 302a-d are configured so, when the baskets 302a-d are nested into each other, the tabs 314a-d on each basket 302a-d and their respective gaps 315 are closely aligned with each other so the bolt 318 of the locking fastener can easily pass through all tabs 314aa-d easily.

In FIG. 13, the collection base 202 is configured to receive the adapter riser 204 to extend the length of a collection chamber defined therein. Then, an array of stacked filter baskets 302a-d, of the configuration shown in FIG. 11, are stacked in place. Such a filter basket includes a rigid outer frame that carries mesh filter media on both the sides and bottom. At least one, preferably more than one mounting tab with the gap 315 therein are attached laterally to the top edge of the filter basket 302a-d of FIG. 14. For example, four tabs 314a-d, each with the gap 315, are provided about the periphery of the basket 302-d. Such tabs 314a-d and gap 315 engage with the pivoting fasteners 316 discussed above to either secure the baskets 302-a-d directly to the top of the collection base 202 or to the top of the riser adapter 204, which is secured to the top of the collection base 202.

One of the problems associated with the use of standard filter/sieve filter bags 54, which are typically made of nylon, is that they are quite flexible so the gap between each successive filter bag 54 cannot be easily controlled so it is possible that two bags 54 are laid up against other, which can reduce the effectiveness of that filtration. Thus, a consistent gap between each successive filter media is preferred. The embodiment of the present invention in FIGS. 11-14 desirably arranges each filter media basket 302a-d at the same distance from each other not only radially but also vertically so the gap between each filter basket 302a-d is the same. This provides more predictable and higher quality collection of cannabis trichomes 42.

While four nested baskets 302a-d are shown, more or less than four baskets 302 may be used depending the needs of the cannabis extraction process and how much granularity of filtration is required.

Therefore, to provide the consistent spacing of the filter baskets 302a-d, the smaller top basket 302a (with a smaller diameter) has longer mounting tabs 314a so it can reach out to the periphery of the spacer/rise member 204 (or the collection base directly) where the complementary tabs 236 are located. Each successive filter basket 302b-d, moving outwardly, get successively larger with a successively larger diameters thereby requiring successively shorter tabs 314b-d. This varying tab length of the nested baskets 302a-d can be seen in FIG. 14.

It should be noted that the distance from the center point of each basket 302a-d to the free end of a tab 314a-d thereon will be the substantially the same, regardless of the basket size and filter pore size. As a result of the selected tab length for each size basket 302a-d will automatically space apart the baskets 302a-d from each other when they are nested and secured in place, as in FIGS. 13 and 14, for example. Such precise and controlled spacing is not possible with flexible filter bags 54. As a result, the filter basket configuration of FIGS. 13 and 14 is more efficient and provides higher performance than possible with other filter media, such as flexible bags 54.

However, as stated above, the apparatus with filter array of the present invention can accommodate both flexible filter bags in embodiment 200 and the embodiment 300 with controlled nested baskets 302a-d of FIGS. 13 and 14. Moreover, the controlled nested baskets 302a-d with rigid frames 304 can be easily and quickly taken apart for cleaning and maintenance and then quickly reassembled. Such structure and function is not found or possible in known filter arrangements, particularly those of collecting cannabis trichomes 42.

It would be appreciated by those skilled in the art that various changes and modifications can be made to the illustrated embodiments without departing from the spirit of the present invention. All such modifications and changes are intended to be covered by the appended claims.

What is claimed is:

1. An apparatus for collecting cannabis trichomes, comprising:
a collection base having a top edge;
a spacer sleeve residing on the collection base; the spacer sleeve having a top edge;
a collection bag adapter residing on a top edge of the spacer sleeve to accommodate flexible filter bags; the collection bag adapter including at least one locking tab about the periphery thereof; and
wherein the at least one locking tab is secured to the top edge of the collection base by a fastener.

2. The apparatus of claim 1, further comprising:
a riser adapter positioned between the collection base and the standard filter adapter.

3. The apparatus of claim 1, further comprising:
a vibrator attached to the collection base.

4. The apparatus of claim 1, wherein the fastener is a pivoting fastener attached to the collection base.

5. A apparatus for collecting cannabis trichomes, comprising:
a collection base having a top edge;
a nested array of filter baskets; each of the filter baskets having at least one locking tab about a periphery thereof;
wherein the at least one locking tab is secured to the top edge of the collection base by a fastener.

6. The apparatus of claim 5, further comprising:
a vibrator attached to the collection base.

7. The apparatus of claim 5, wherein the fastener is a pivoting fastener attached to the collection base.

8. The apparatus of claim 3, further comprising:
a riser adapter positioned on the collection base.

9. The apparatus of claim 5, wherein the at least one locking tab of each of the nested array of baskets are configured to have a length wherein the tabs that are vertically stacked over each other to co-terminate with each other and are configured and arranged to be secured to a riser adapter or collection base using a single fastener.

10. The apparatus of claim 5, wherein a plurality of locking tabs of respective baskets are vertically stacked over each other at more than one location about the periphery of a nested filter basket array.
